(19) United States
(12) Patent Application Publication
(10) Pub. No.: US 2025/0306432 A1
(43) Pub. Date: Oct. 2, 2025

(54) ACTUATOR FOR CAMERA

(71) Applicant: SAMSUNG ELECTRO-MECHANICS CO., LTD., Suwon-si (KR)

(72) Inventors: Ji Buem CHUN, Suwon-si (KR); Hong Joo LEE, Suwon-si (KR); Jae Hyung HAN, Suwon-si (KR)

(73) Assignee: SAMSUNG ELECTRO-MECHANICS CO., LTD., Suwon-si (KR)

(21) Appl. No.: 18/922,671

(22) Filed: Oct. 22, 2024

(30) Foreign Application Priority Data
Mar. 27, 2024 (KR) 10-2024-0041806

(51) Int. Cl. G03B 5/00; G03B 3/10

(52) U.S. Cl. CPC G03B 5/00; G03B 3/10; G03B 2205/0069

(57) ABSTRACT

An actuator for a camera includes a housing having an internal space; a first carrier disposed in the housing; a second carrier disposed in the first carrier; an image sensor fixed to the second carrier; a first driving unit configured to move the first carrier, relative to the housing, in a direction parallel to an imaging surface of the image sensor, the first driving unit including a coil portion disposed on the first carrier; and a second driving unit configured to move the second carrier, relative to the first carrier, in a direction perpendicular to the imaging surface, the second driving unit including a first magnet disposed on the second carrier.

### CROSS-REFERENCE TO RELATED APPLICATIONS

This application claims the benefit under 35 USC 119(a) of Korean Patent Application No. 10-2024-0041806 filed on Mar. 27, 2024, in the Korean Intellectual Property Office, the entire disclosure of which is incorporated herein by reference for all purposes.

### BACKGROUND

### 1. Field

The following disclosure relates to an actuator for a camera.

### 2. Description of the Background

In recent years, a camera module has been used in a mobile communications terminal, such as a tablet personal computer (PC) or a laptop computer, as well as a smartphone.

In addition, the camera module may include an actuator having autofocus (AF) and optical image stabilization (OIS) functions to generate a high-resolution image.

For example, the actuator may perform the autofocus (AF) function by moving a lens module in an optical axis (Z-axis) direction, or perform the optical image stabilization (OIS) function by moving the lens module in a direction perpendicular to an optical axis (Z-axis).

However, camera modules tend to increase in weight as performance increases. In addition, there is also an effect of the weight of a driving unit for moving the lens module, which may make it more difficult to precisely control the driving force for performing the AF or OIS function.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an actuator for a camera includes a housing having an internal space; a first carrier disposed in the housing; a second carrier disposed in the first carrier; an image sensor fixed to the second carrier; a first driving unit configured to move the first carrier, relative to the housing, in a direction parallel to an imaging surface of the image sensor, the first driving unit including a coil portion disposed on the first carrier; and a second driving unit configured to move the second carrier, relative to the first carrier, in a direction perpendicular to the imaging surface, the second driving unit including a first magnet disposed on the second carrier.

The first driving unit may include a first sub driving unit configured to move the first carrier in a first direction intersecting an optical axis, and a second sub driving unit configured to move the first carrier in a second direction intersecting both the optical axis and the first direction.

The coil portion may include a first coil included in the first sub driving unit, and a second coil included in the second sub driving unit.

The second driving unit may include a third coil disposed on the first carrier, and the third coil may face the first magnet disposed on the second carrier.

The first coil may include a plurality of first coils, and the second coil may include a plurality of second coils.

The second driving unit may overlap the first sub driving unit in the first direction.

The actuator may further include a Hall sensor facing the first magnet.

The first sub driving unit may include a second magnet disposed in the housing, and the second sub driving unit may include a third magnet disposed in the housing.

The first sub driving unit may be configured to generate a driving force in the first direction, and the second sub driving unit may be configured to generate a driving force in the second direction.

The first driving unit may include a second magnet disposed in the housing.

The second magnet may have north (N) and south (S) poles disposed in the direction perpendicular to the imaging surface.

The first magnet may have north (N) and south (S) poles disposed in a direction parallel to an optical axis.

The second driving unit may include a Hall sensor facing the first magnet.

The actuator may further include a sensor board including a moving part on which the image sensor is disposed, a fixed part mounted on the housing, and a connecting part connecting the moving part and the fixed part to each other.

The moving part may be coupled to the second carrier.

The connecting part may be disposed along a perimeter of the moving part.

Other features and aspects will be apparent from the following detailed description, the drawings, and the claims.

### BRIEF DESCRIPTION OF DRAWINGS

FIG. 1 is a perspective view of a camera module according to an embodiment of the present disclosure.

FIG. 2 is a cross-sectional view taken along line I-I′ of FIG. 1.

FIG. 3 is a schematic exploded perspective view of the camera module according to an embodiment of the present disclosure.

FIG. 4 is an exploded perspective view illustrating a housing, a first carrier, and a first driving unit according to an embodiment of the present disclosure.

FIG. 5 is a bottom view of the housing according to an embodiment of the present disclosure.

FIG. 6 is a cross-sectional view taken along line II-II′ of FIG. 1.

FIG. 7 is a perspective view of the first driving unit according to an embodiment of the present disclosure.

FIG. 8 is a plan view of a sensor board of an actuator according to an embodiment of the present disclosure.

FIG. 9 is a cross-sectional view taken along line III-III′ of FIG. 8.

FIG. 10 is an exploded perspective view illustrating the first carrier, a second carrier, and a second driving unit according to an embodiment of the present disclosure.

FIG. 11 is a perspective view of the components shown in FIG. 10, viewed from another direction.

FIG. 12 is a side view of the second carrier.

FIG. 13 is a schematic cross-sectional view of a camera module according to another embodiment of the present disclosure.

FIG. 14 is a schematic cross-sectional view of a camera module according to another embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

According to an embodiment of the present disclosure, a camera module may be mounted on a portable electronic device. The portable electronic device may be a mobile electronic device such as a mobile communications terminal, a smartphone, or a tablet personal computer (PC).

In the specification, a direction in which an imaging surface of an image sensor S is oriented may be referred to as an optical axis (Z-axis) direction.

In the specification, the fact that the image sensor S is moved to be parallel to the imaging surface of the image sensor S may be understood as the image sensor S is moved in a direction perpendicular to an optical axis (Z-axis).

In addition, a first axis direction (X-axis direction) and a second axis direction (Y-axis direction) may be examples of two directions perpendicular to the optical axis (Z-axis) and intersecting each other. In the specification, the first axis direction (X-axis direction) and the second axis direction (Y-axis direction) may be understood as two directions perpendicular to the optical axis (Z-axis) and intersecting each other.

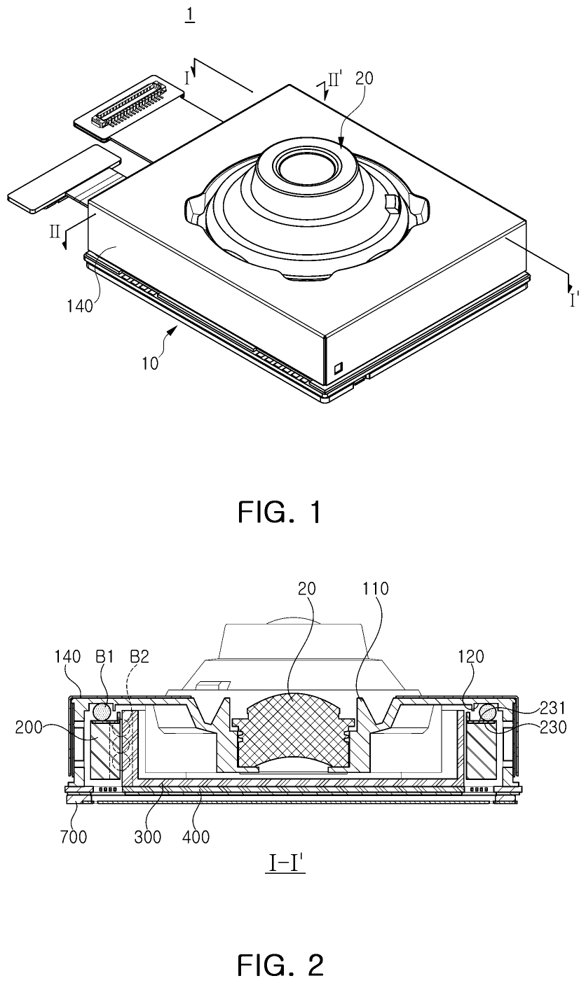

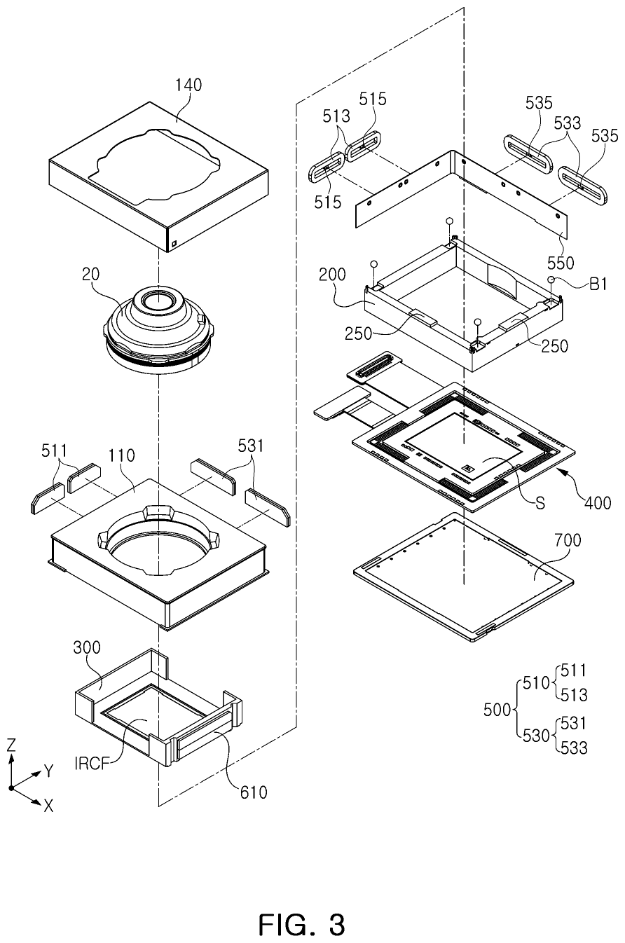

FIG. 1 is a perspective view of a camera module according to an embodiment of the present disclosure. FIG. 2 is a cross-sectional view taken along line I-I′ of FIG. 1. FIG. 3 is a schematic exploded perspective view of the camera module according to an embodiment of the present disclosure.

Referring to FIGS. 1 through 3, a camera module 1, according to an embodiment of the present disclosure, may include a lens module 20 and an actuator 10 for a camera (hereinafter, referred to as “the actuator”).

The lens module 20 includes one or more lenses and lens barrels. One or more lenses may be disposed in the lens barrel. When the plurality of lenses is provided, the plurality of lenses may be mounted in the lens barrel along the optical axis (Z-axis).

The lens module 20 may be coupled to a housing 110. The housing 110 may be formed in a square box shape with a through part passing through in the optical axis (Z-axis) direction, and the lens module 20 may be inserted into the through part of the housing 110 and fixed to the housing 110.

In an embodiment of the present disclosure, the lens module 20 may be a fixed member fixed to the housing 110. For example, the lens module 20 may be the fixed member that is not moved during an automatic autofocus (AF) operation or an optical image stabilization (OIS) operation.

The camera module 1, according to an embodiment of the present disclosure, may perform the AF function and the OIS function by moving the image sensor S rather than the lens module 20. The camera module 1 may move the relatively light image sensor S, thus using relatively less driving force to move the image sensor S. It is thus possible to downsize a part included in the actuator 10.

The actuator 10 may include the housing 110, a first carrier 200, and a second carrier 300.

The first carrier 200 may be accommodated in the housing 110 and moved relative to the housing 110 in the direction perpendicular to the optical axis (Z-axis). That is, the first carrier 200 may be a fixed member that is not moved in the optical axis (Z-axis) direction during the AF operation, and may be a moving member that is moved in the direction perpendicular to the optical axis (Z-axis) during the OIS operation.

The second carrier 300 may be accommodated in the first carrier 200 and moved relative to the first carrier 200 in the direction perpendicular to the optical axis (Z-axis). In addition, the second carrier 300 may be restrained from moving relative to the first carrier 200 in the direction perpendicular to the optical axis (Z-axis). Therefore, when the first carrier 200 is moved in the direction perpendicular to the optical axis (Z-axis), the second carrier 300 may be moved together with the first carrier 200 in the direction perpendicular to the optical axis (Z-axis).

The image sensor S may be fixed to the second carrier 300 and moved together with the second carrier 300.

Therefore, the image sensor S may perform the AF function by being moved together with the second carrier 300 in the optical axis (Z-axis) direction, and perform the OIS function by being moved together with the second carrier 300 in the direction perpendicular to the optical axis (Z-axis).

The second carrier 300 may be mounted with an infrared ray cut filter (IRCF).

The actuator 10 may further include a case 140. The case 140 may be coupled to the housing 110 and protect an internal component of the actuator 10.

The image sensor S may be mounted on a sensor board 400. The sensor board 400 may have one portion coupled to the second carrier 300 and the other portion coupled to the housing 110.

The image sensor S may be mounted on one portion of the sensor board 400 that is coupled to the second carrier 300.

One portion of the sensor board 400 may be coupled to the second carrier 300, and as the second carrier 300 is moved, one portion of the sensor board 400 may also be moved together with the second carrier 300.

Therefore, the image sensor S may perform the AF function by being moved in the optical axis (Z-axis) direction and the OIS function by being moved in the direction perpendicular to the optical axis (Z-axis).

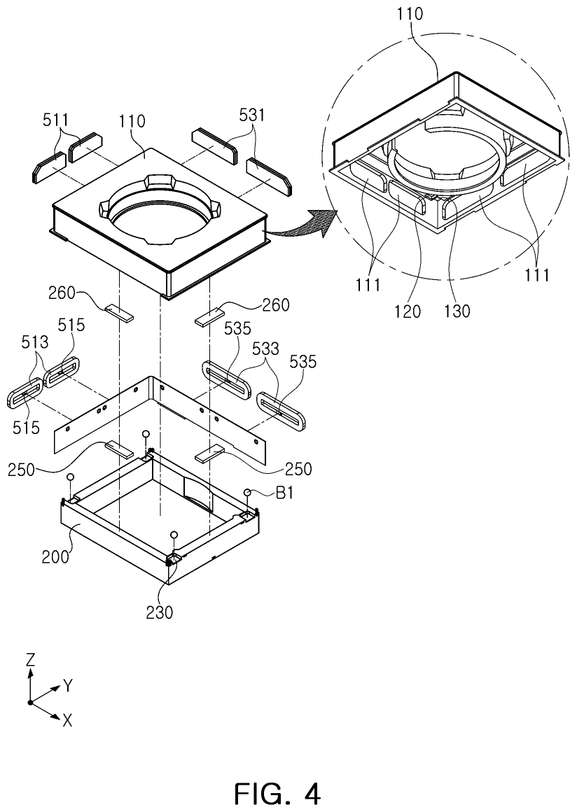

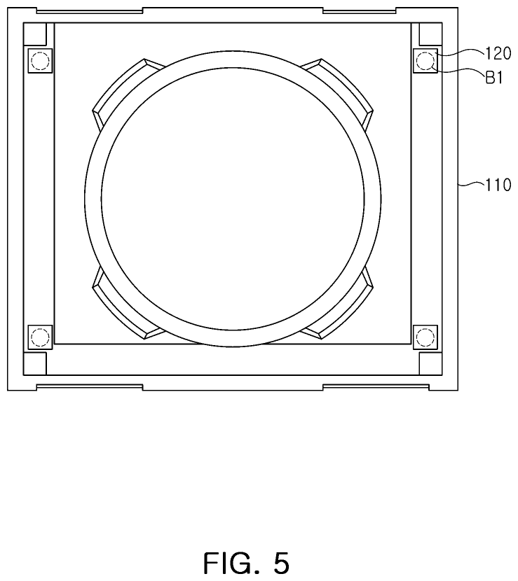

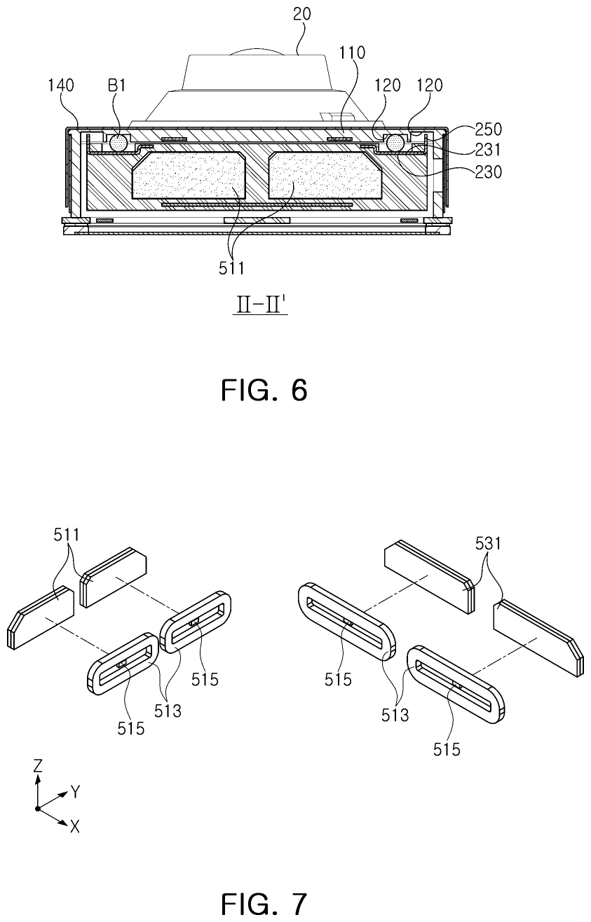

FIG. 4 is an exploded perspective view illustrating the housing, the first carrier, and a first driving unit according to an embodiment of the present disclosure; FIG. 5 is a bottom view of the housing according to an embodiment of the present disclosure; FIG. 6 is a cross-sectional view taken along line II-II′ of FIG. 1; and FIG. 7 is a perspective view of the first driving unit according to an embodiment of the present disclosure.

Referring to FIGS. 4 through 7, the first carrier 200 may be disposed in the housing 110. In the housing 110, the first carrier 200 may be moved relative to the housing 110 in the first axis direction (X-axis direction) or the second axis direction (Y-axis direction).

The first axis direction (X-axis direction) may indicate the direction perpendicular to the optical axis (Z-axis), and the second axis direction (Y-axis direction) may indicate a direction perpendicular to both the optical axis (Z-axis) direction and the first axis direction (X-axis).

The actuator 10, according to an embodiment of the present disclosure, may include a first driving unit 500. The first driving unit 500 may generate driving force in the direction perpendicular to the optical axis (Z-axis) to thus move the first carrier 200 in the direction perpendicular to the optical axis (Z-axis). The first driving unit 500 may include a magnet part with a plurality of magnets and a coil portion with a plurality of coils. That is, the magnet unit may include a first magnet 511 included in a first sub driving unit 510 and a second magnet 531 included in a second sub driving unit 530, which are described below. In addition, the coil portion may include a first coil 513 included in the first sub driving unit 510 and a second coil 533 included in the second sub driving unit 530, which are described below.

The first driving unit 500 may include the first sub driving unit 510 and the second sub driving unit 530. The first sub driving unit 510 may generate the driving force in the first axis direction (X-axis direction), and the second sub driving unit 530 may generate the driving force in the second axis direction (Y-axis direction).

The first sub driving unit 510 may include a driving magnet and a driving coil. Here, the driving magnet included in the first sub driving unit 510 may be referred to as the first magnet 511, and the driving coil included in the first sub driving unit 510 may be referred to as the first coil 513. The first magnet 511 and the first coil 513 may overlap each other in the first axis direction (X-axis direction) intersecting the optical axis (Z-axis).

The first coil 513 may be disposed on a first board 550. The first board 550 may be mounted on the first carrier 200 for the first magnet 511 and the first coil 513 to face each other in the direction perpendicular to the optical axis (Z-axis). The first board 550 is shown as being coupled to the outside of the first carrier 200 in the drawing. However, the first board 550 may be coupled to the first carrier 200 through insert injection. That is, the first board 550 may be integrated with the first carrier 200, and include a conductor capable of transmitting an electrical signal.

The first coil 513 may have a hollow donut shape, and may be long in the second axis direction (Y-axis direction). The first coil 513 may be disposed on the first board 550. In addition, the first coil 513 may be a copper foil pattern printed on the first board 550.

The first magnet 511 may face the first coil 513. For example, the first magnet 511 may face the first coil 513 in the direction perpendicular to the optical axis (Z-axis).

The housing 110 may include a mounting groove 111. The mounting groove 111 may be a groove inserted from an inner surface of the housing 110 to an outer surface of the housing 110 in the direction perpendicular to the optical axis. Alternatively, the mounting groove 111 may be a hole passing through side surfaces of the housing 110 in the direction intersecting the optical axis. The first magnet 511 may be disposed in the mounting groove 111 of the housing 110. It is possible to prevent the sizes of the actuator 10 and the camera module 1 from increasing due to the thickness of the first magnet 511 by disposing the first magnet 511 in the mounting groove 111 of the housing 110.

The first magnet 511 may be magnetized to have one surface (e.g., surface facing the first coil 513) having a south(S) pole or a north (N) pole. For example, when one surface of the first magnet 511 that faces the first coil 513 has the N pole, the other surface of the first magnet 511 (e.g., surface opposite to one surface) may be magnetized to have the S pole.

The first magnet 511 may include one or more magnets, and the first coil 513 may include coils of the number corresponding to the number of magnets included in the first magnet 511.

For example, when the first magnet 511 includes only one magnet, the first coil 513 may also include one coil, and when the first magnet 511 includes the plurality of magnets, the first coil 513 may also include the plurality of coils.

The first coil 513 may be a moving member mounted on the first carrier 200 with the first board 550 and moved with the first carrier 200, and the first magnet 511 may be a fixed member fixed to the housing 110.

When power is applied to the first coil 513, the first carrier 200 may be moved in the first axis direction (X-axis direction) by an electromagnetic force between the first magnet 511 and the first coil 513. It is possible to more precisely control the movement of the first carrier 200 and save energy used to move the first carrier 220 by disposing the first coil 513, which is lighter than the first magnet 511, on the first carrier 200, which is the moving member.

The second sub driving unit 530 may include the driving magnet and the driving coil. Here, the driving magnet included in the second sub driving unit 530 may be referred to as the second magnet 531, and the driving coil included in the second sub driving unit 530 may be referred to as the second coil 533.

The second coil 533 may be disposed on the first board 550. The first board 550 may be mounted on the first carrier 200 for the second magnet 531 and the second coil 533 to face each other in the direction perpendicular to the optical axis (Z-axis). The first board 550 is shown as being coupled to the outside of the first carrier 200 in the drawing. However, the first board 550 may be coupled to the first carrier 200 through insert injection. That is, the first board 550 may be integrated with the first carrier 200, and include the conductor capable of transmitting the electrical signal.

The second coil 533 may have a hollow donut shape and may be long in the first axis direction (X-axis direction). The second coil 533 may be disposed on the first board 550. In addition, the second coil 533 may be the copper foil pattern printed on the first board 550.

The second magnet 531 may face the second coil 533. For example, the second magnet 531 may face the second coil 533 in the direction perpendicular to the optical axis (Z-axis).

The housing 110 may include the mounting groove 111. The mounting groove 111 may be the groove inserted from the inner surface of the housing 110 to the outer surface of the housing 110 in the direction perpendicular to the optical axis. Alternatively, the mounting groove 111 may be the hole passing through the side surfaces of the housing 110 in the direction intersecting the optical axis. The second magnet 531 may be disposed in the mounting groove 111 of the housing 110. It is possible to prevent the sizes of the actuator 10 and the camera module 1 from being increased due to the thickness of the second magnet 531 by disposing the second magnet 531 in the mounting groove 111 of the housing 110.

The second magnet 531 may be magnetized to have one surface (e.g., surface facing the second coil 533) with the N or S poles. For example, when one surface of the second magnet 531 that faces the second coil 533 has the N pole, the other surface of the second magnet 531 (e.g., surface opposite to one surface) may be magnetized to have the S pole.

The second magnet 531 may include one or more magnets, and the second coil 533 may include coils of the number corresponding to the number of magnets included in the second magnet 531.

For example, when the second magnet 531 includes only one magnet, the second coil 533 may also include one coil, and when the second magnet 531 includes the plurality of magnets, the second coil 533 may also include the plurality of coils.

The second coil 533 may be a moving member mounted on the first carrier 200 with the first board 550 and moved with the first carrier 200, and the second magnet 531 may be a fixed member fixed to the housing 110.

When the power is applied to the second coil 533, the first carrier 200 may be moved in the second axis direction (Y-axis direction) by an electromagnetic force between the second magnet 531 and the second coil 533. Meanwhile, it is possible to rotate the first carrier 200 by setting a magnitude of the driving force in the first axis direction (X-axis direction) and a magnitude of the driving force in the second axis direction (Y-axis direction) to be different from each other.

It is possible to more precisely control the movement of the first carrier 200 and save the energy used to move the first carrier 220 by disposing the second coil 533, which is lighter than the second magnet 531, on the first carrier 200, which is the moving member.

A first ball member B1 may be disposed between the housing 110 and the first carrier 200.

The first ball member B1 may be in contact with each of the housing 110 and the first carrier 200.

The first ball member B1 may function to guide the movement of the first carrier 200 during the OIS operation. The first ball member B1 may also function to maintain a distance between the housing 110 and the first carrier 200 in the optical axis (Z-axis) direction.

The first ball member B1 may guide the movement of the first carrier 200 by performing a rolling motion in the direction perpendicular to the optical axis (Z-axis) when the first carrier 200 is moved relative to the housing 110 in the direction perpendicular to the optical axis (Z-axis).

For example, the first ball member B1 may perform the rolling motion in the first axis direction (X-axis direction) when the driving force is generated in the first axis direction (X-axis direction). Accordingly, the first ball member B1 may guide the movement of the first carrier 200 in the first axis direction (X-axis direction).

In addition, the first ball member B1 may perform the rolling motion in the second axis direction (Y-axis direction) when the driving force is generated in the second axis direction (Y-axis direction). Accordingly, the first ball member B1 may guide the movement of the first carrier 200 in the second axis direction (Y-axis direction).

The first ball member B1 may include a plurality of balls disposed between the housing 110 and the first carrier 200. The number of balls included in the first ball member B1 may be three or more.

A guide groove, in which the first ball member B1 is disposed, may be disposed in at least one of the surfaces where the housing 110 and the first carrier 200 face each other in the optical axis (Z-axis) direction. For example, a first guide groove 230 may be disposed in an upper surface of the first carrier 200, and a second guide groove 120 may be disposed in the inner upper surface of the housing 110.

The first ball member B1 may be disposed in the first guide groove 230 and the second guide groove 120 to be inserted between the housing 110 and the first carrier 200.

While the first ball member B1 is accommodated in the first guide groove 230 and the second guide groove 120, the movement of the first ball member B1 in the optical axis (Z-axis) direction may be restricted and moved in the direction perpendicular to the optical axis (Z-axis).

The first guide groove 230 and the second guide groove 120 may each have a polygonal or circular planar shape. Sizes of the first guide groove 230 and the second guide groove 120 may be larger than the diameter of the first ball member B1. For example, a cross-section of the first guide groove 230 or the second guide groove 120 on a plane perpendicular to the optical axis (Z-axis) may be larger than the diameter of the first ball member B1.

Meanwhile, the first carrier 200 may include a support pad 231, and at least a portion of the support pad 231 may form a bottom surface of the first guide groove 230. Accordingly, the first ball member B1 may roll in contact with the support pad 231.

The support pad 231 may be integrated with the first carrier 200 by the insert injection. In this case, the support pad 231 may be manufactured to be integrated with the first carrier 200 by injecting a resin material into a mold while the support pad 231 is fixed to the inside of the mold. The support pad 231 may be made of a stainless material. The support pad 231 may also be disposed in the housing 110.

The actuator 10, according to an embodiment of the present disclosure, may detect a position of the first carrier 200 in the direction perpendicular to the optical axis (Z-axis).

To this end, a first position sensor 515 and a second position sensor 535 may be provided. The first position sensor 515 may be disposed on the first board 550 and face the first magnet 511, and the second position sensor 535 may be disposed on the first board 550 and face the second magnet 531.

The first position sensor 515 and the second position sensor 535 may each include one or more Hall sensors.

The first position sensor 515 may include two Hall sensors. The two Hall sensors of the first position sensor 515 may be spaced apart from each other in the second axis direction (Y-axis direction). A direction in which the two Hall sensors of the first position sensor 515 are spaced apart from each other and a direction in which the first magnet 511 and the first coil 513 face each other may be perpendicular to each other.

For example, the first magnet 511 may include two magnets spaced apart from each other in the direction (or the second axis direction (Y-axis direction)) perpendicular to the direction (or the first axis direction (X-axis direction)) in which the driving force is generated by the first magnet 511, and the first position sensor 515 may include two Hall sensors facing two magnets.

The actuator 10 may detect whether the first carrier 200 is rotated through two Hall sensors facing the first magnet 511.

The second position sensor 535 may include two Hall sensors. The two Hall sensors of the second position sensor 535 may be spaced apart from each other in the first axis direction (X-axis direction). A direction in which the two Hall sensors of the second position sensor 535 are spaced apart from each other and a direction in which the second magnet 531 and the second coil 533 face each other may be perpendicular to each other.

For example, the second magnet 531 may include two magnets spaced apart from each other in the direction (or the first axis direction (X-axis direction)) perpendicular to the direction (or the second axis direction (Y-axis direction)) in which the driving force is generated by the second magnet 531, and the second position sensor 535 may include two Hall sensors facing two magnets.

The actuator 10 may detect whether the first carrier 200 is rotated through two Hall sensors facing the second magnet 531.

Meanwhile, it is possible to intentionally generate a rotational force by generating a deviation between the driving force of the first sub driving unit 510 and the driving force of the second sub driving unit 530, using a resultant force of the first sub driving unit 510 and the second sub driving unit 530, or using two magnets included in the second sub driving unit 530.

The first guide groove 230 and the second guide groove 120 may each have a polygonal or circular planar shape larger than the diameter of the first ball member B1. Therefore, the first ball member B1 may perform the rolling motion in several directions perpendicular to the optical axis (Z-axis).

Accordingly, the first carrier 200 may be rotated about the optical axis (Z-axis) while being supported by the first ball member B1.

Meanwhile, for convenience, the description describes that the first carrier 200 is rotated while having the optical axis (Z-axis) as its rotation axis. However, the rotation axis may not coincide with the optical axis (Z-axis) when the first carrier 200 is rotated. For example, the first carrier 200 may be rotated using, as its rotation axis, an arbitrary axis parallel to a direction in which the imaging surface of the image sensor S faces.

In addition, when the first carrier 200 requires a linear movement rather than rotation, it is possible to control the driving force of the first sub driving unit 510 and/or the driving force of the second sub driving unit 530, thereby offsetting any rotational force unintentionally occurring therein.

A pulling magnet 250 or a pulling yoke 260 may be disposed on the upper surface of the first carrier 200. The pulling magnet 250 or the pulling yoke 260 may be disposed on an upper surface of a sidewall of the first carrier 200 where the first coil 513 or the second coil 533 is not disposed.

When the pulling magnet 250 is disposed on the upper surface of the first carrier 200, the pulling yoke 260 may be disposed on the inner side of the housing 110 and face the pulling magnet 250.

When the pulling yoke 260 is disposed on the upper surface of the first carrier 200, the pulling magnet 250 may be disposed on the inner side of the housing 110 and face the pulling yoke 260.

The first carrier 200 and the housing 110 may be pulled together in a direction approximately parallel to the optical axis by magnetic attraction generated between the pulling yoke 260 and the pulling magnet 250.

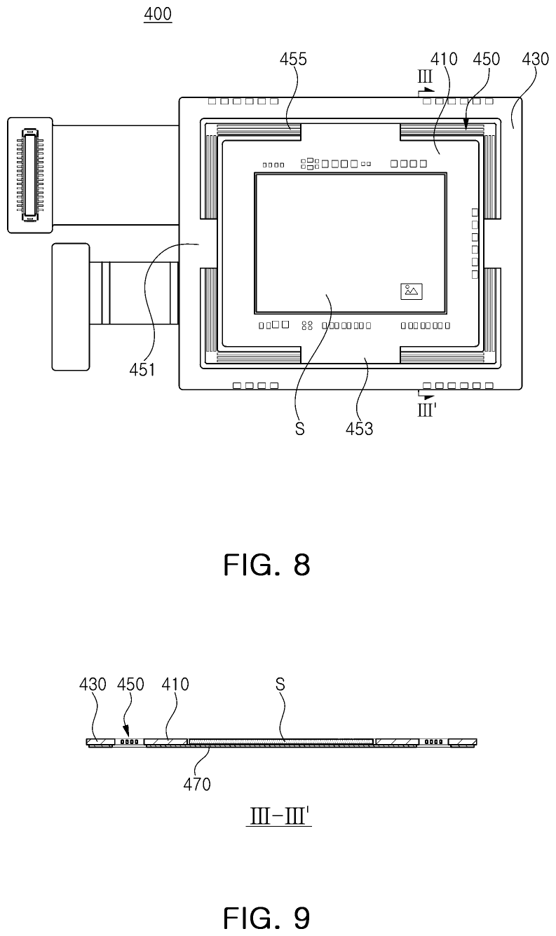

FIG. 8 is a plan view of the sensor board of the actuator according to an embodiment of the present disclosure; and FIG. 9 is a cross-sectional view taken along line III-III′ of FIG. 8.

Referring to FIGS. 8 and 9, the sensor board 400 may include a moving part 410, a fixed part 430, and a connecting part 450. The sensor board 400 may be a rigid-flex printed circuit board (RF PCB).

The image sensor S may be mounted on the moving part 410. The moving part 410 may be coupled to a lower surface of the second carrier 300 described below. For example, the area of the moving part 410 may be larger than the area of the image sensor S, and the moving part 410 on an outer portion of the image sensor S may be coupled to the lower surface of the second carrier 300.

The moving part 410 may be the moving member moved together with the first carrier 200 and the second carrier 300 during the OIS operation. The moving part 410 may be a rigid printed circuit board (RPCB).

The fixed part 430 may be coupled to a lower surface of the housing 110. The fixed part 430 may be a fixed member that is not moved during the OIS operation. The fixed part 430 may be the rigid printed circuit board (RPCB).

The connecting part 450 may be disposed between the moving part 410 and the fixed part 430, and connect the moving part 410 and the fixed part 430 to each other. The connecting part 450 may be a flexible printed circuit board (FPCB). When the moving part 410 is moved, the connecting part 450 disposed between the moving part 410 and the fixed part 430 may be bent.

The connecting part 450 may extend along a perimeter of the moving part 410. The connecting part 450 may include a plurality of slits passing through the connecting part 450 in the optical axis (Z-axis) direction. The plurality of slits may be disposed between the moving part 410 and the fixed part 430 while having a distance therebetween. Accordingly, the connecting part 450 may include a plurality of bridge elements 455 spaced apart from each other by the plurality of slits. The plurality of bridge elements 455 may extend along the perimeter of the moving part 410.

The connecting part 450 may include a first support part 451 and a second support part 453. The connecting part 450 may be connected to the fixed part 430 by the first support part 451. In addition, the connecting part 450 may be connected to the moving part 410 by the second support part 453.

For example, the first support part 451 may be contact-connected to the fixed part 430, and spaced apart from the moving part 410. In addition, the second support part 453 may be contact-connected to the moving part 410, and spaced apart from the fixed part 430.

For example, the first support part 451 may extend in the first axis direction (X-axis direction) to thus connect the plurality of bridge elements 455 of the connecting part 450 and the fixed part 430 to each other. In an embodiment, the first support part 451 may include two supports disposed to be opposite each other in the first axis direction (X-axis direction).

The second support part 453 may extend in the second axis direction (Y-axis direction) to thus connect the plurality of bridge elements 455 of the connecting part 450 and the moving part 410 to each other. In an embodiment, the second support part 453 may include two supports disposed to be opposite each other in the second axis direction (Y-axis direction).

Accordingly, the moving unit 410 may be moved in the direction perpendicular to the optical axis (Z-axis) or rotated about the optical axis (Z-axis) while being supported by the connecting part 450.

In an embodiment, when the image sensor S is moved in the first axis direction (X-axis direction), the plurality of bridge elements 455 connected to the first support part 451 may be bent. In addition, when the image sensor S is moved in the second axis direction (Y-axis direction), the plurality of bridge elements 455 connected to the second support part 453 may be bent. In addition, when the image sensor S is rotated, the plurality of bridge elements 455 connected to the first support part 451 and the plurality of bridge elements 455 connected to the second support part 453 may be bent together.

In an embodiment, the length of the fixed part 430 in the first axis direction (X-axis direction) and the length of the fixed part 430 in the second axis direction (Y-axis direction) may differ. For example, the length of the fixed part 430 in the second axis direction (Y-axis direction) may be longer than the length of the fixed part 430 in the first axis direction (X-axis direction). In an embodiment, the sensor board 400 may have an overall rectangular shape.

In this type of sensor board 400, when the length of the first support part 451 and the length of the second support part 453 are the same as each other, a load applied to the plurality of bridge elements 455 connected to the first support part 451 and a load applied to the plurality of bridge elements 455 connected to the second support part 453 may become different from each other, which may cause difficulties in controlling the operation of the camera module.

Therefore, it is possible to make the length of the first support part 451 and the length of the second support part 453 different from each other to thus enable each length of the plurality of bridge elements 455 extending from the first support part 451 in the second axis direction (Y-axis direction) and each length of the plurality of bridge elements 455 extending from the second support part 453 in the first axis direction (X-axis direction) to be approximately the same as each other.

Here, the length of the first support part 451 may indicate its length in the second axis direction (Y-axis direction), and the length of the second support part 453 may indicate its length in the first axis direction (X-axis direction).

Referring to FIG. 9, a through hole may be disposed in the moving part 410, and the image sensor S may be disposed in the through hole. The thickness of the through hole and the thickness of the image sensor S may be approximately the same as each other.

In addition, a reinforcement plate 470 may be coupled to a lower surface of the moving part 410. The reinforcement plate 470 may also be coupled to a lower surface of the fixed part 430.

Therefore, compared to a case where the image sensor S is disposed on an upper surface of the sensor board 400, the height of the sensor board 400 in the optical axis (Z-axis) direction may be reduced by the thickness of the image sensor S.

Meanwhile, referring to FIG. 2, a base 700 may be coupled to a lower portion of the sensor substrate 400.

The base 700 may be coupled to the sensor board 400 and cover the lower portion of the sensor board 400. The base 700 may serve to prevent an external foreign material or the like from entering through a distance between the moving part 410 and fixed part 430 of the sensor board 400.

A heat dissipation film may be disposed on the lower portion of the base 700. Therefore, heat occurring in the image sensor S may be effectively dissipated.

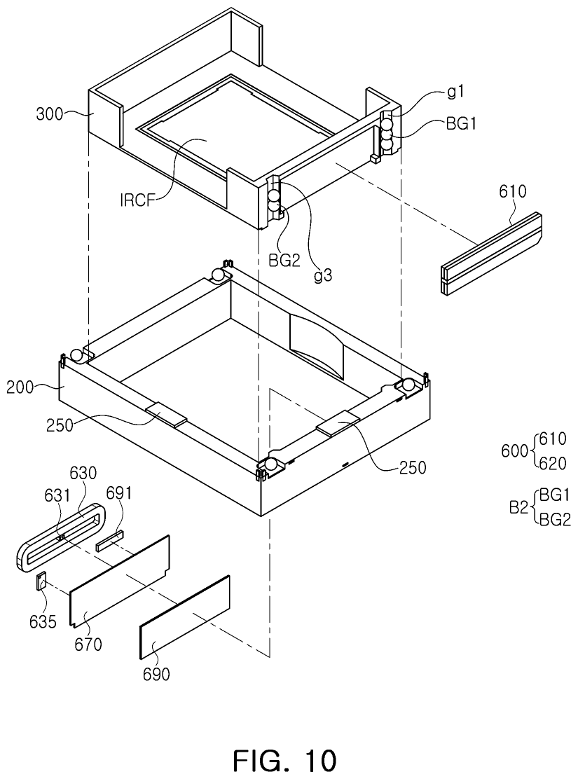

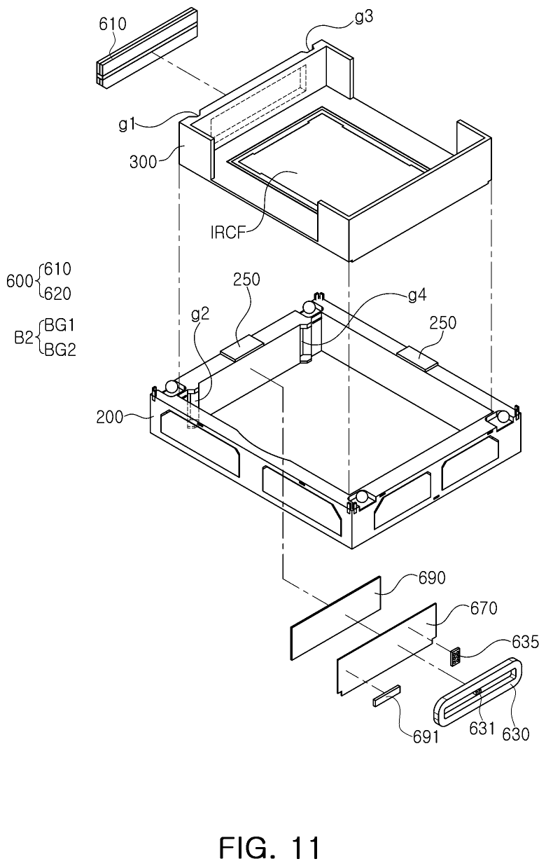

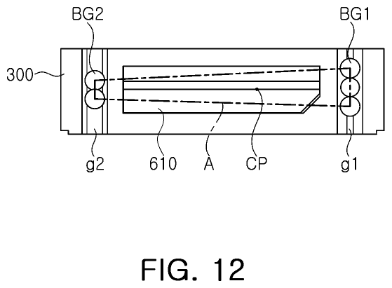

FIG. 10 is an exploded perspective view illustrating the first carrier, the second carrier, and a second driving unit according to an embodiment of the present disclosure. FIG. 11 is a perspective view of the components shown in FIG. 10, viewed from another direction. FIG. 12 is a side view of the second carrier.

Referring to FIGS. 10 and 11, the second carrier 300 may be disposed in the first carrier 200.

The second carrier 300 may be disposed in the first carrier 200, moved together with the first carrier 200 in the direction perpendicular to the optical axis (Z-axis), and moved relative to the first carrier 200 in the optical axis (Z-axis) direction.

A second driving unit 600 may generate the driving force in the optical axis (Z-axis) direction to move the second carrier 300 in the optical axis (Z-axis) direction.

The second sub driving unit 600 may include a driving magnet and a driving coil. Here, the driving magnet included in the second driving unit 600 may be referred to as a third magnet 610, and the driving coil included in the second driving unit 600 may be referred to as a third coil 630.

The third magnet 610 and the third coil 630 may face each other in the direction perpendicular to the optical axis (Z-axis).

The third magnet 610 may be disposed on the second carrier 300. For example, the third magnet 610 may be disposed on an outer surface of the second carrier 300. The third magnet 610 may overlap the first magnet 511 in the first axis direction (X-axis direction).

One surface (e.g., the surface facing the third coil 630) of the third magnet 610 may be magnetized to have both the N and S poles. For example, one surface of the third magnet 610 that faces the third coil 630 may include the N pole, a neutral region, and the S pole sequentially formed in the optical axis (Z-axis) direction.

The other surface (e.g., the surface opposite to one surface) of the third magnet 610 may be magnetized to have both the S and N poles. For example, the other surface of the third magnet 610 may sequentially have the S pole, the neutral region, and the N pole in the optical axis (Z-axis) direction.

The third coil 630 may be disposed on the first carrier 200. For example, the third coil 630 may be disposed on an inner surface of the first carrier 200. The third coil 630 may face the third magnet 610 in the direction perpendicular to the optical axis (Z-axis).

The third coil 630 may be disposed on a second board 670, the second board 670 may be mounted on the first carrier 200 for the third magnet 610 and the third coil 630 to face each other in the direction perpendicular to the optical axis (Z-axis).

During the AF operation, the third magnet 610 may be the moving member moved together with the second carrier 300 in the optical axis (Z-axis) direction, and the third coil 630 may be the fixed member fixed to the second board 670 and the first carrier 200.

When the power is applied to the third coil 630, the second carrier 300 may be moved in the optical axis (Z-axis) direction by an electromagnetic force between the third magnet 610 and the third coil 630.

The sensor board 400 mounted with the image sensor S may be coupled to the second carrier 300, and the image sensor S may thus also be moved in the optical axis (Z-axis) direction by the movement of the second carrier 300.

A second ball member B2 may be disposed between the first carrier 200 and the second carrier 300. The second ball member B2 may include a plurality of balls disposed in the optical axis (Z-axis) direction. The plurality of balls may perform the rolling motions in the optical axis (Z-axis) direction when the second carrier 300 is moved in the optical axis (Z-axis) direction.

A second yoke 690 may be disposed on the first carrier 200. The second yoke 690 may face the third magnet 610. For example, the third coil 630 may be disposed on one surface of the second board 670, and the second yoke 690 may be disposed on the other surface of the second board 670.

The third magnet 610 and the second yoke 690 may generate magnetic attraction between each other. For example, the attraction may act between the third magnet 610 and the second yoke 690 in the direction perpendicular to the optical axis (Z-axis).

The second ball member B2 may be in contact with each of the first carrier 200 and the second carrier 300 by the attraction between the third magnet 610 and the second yoke 690.

A guide groove may be disposed in a surface where the first carrier 200 and the second carrier 300 face each other. For example, a first groove g1 and a third groove g3 may be disposed in the second carrier 300, and a second groove g2 and a fourth groove g4 may be disposed in the first carrier 200. Each groove may be long in the optical axis (Z-axis) direction.

The first groove g1 and the second groove g2 may face each other in the direction perpendicular to the optical axis (Z-axis), and some (e.g., first ball group BG1 described below) of the plurality of balls in the second ball member B2 may be disposed in a space between the first groove g1 and the second groove g2.

Among a plurality of balls included in the first ball group BG1, balls disposed at the outermost side in a direction parallel to the optical axis (Z-axis) may each be in two-point contact with the first groove g1 and the second groove g2.

That is, among the plurality of balls included in the first ball group BG1, the outermost balls in the direction parallel to the optical axis (Z-axis) may be in two-point contact with the first groove g1 and in two-point contact with the second groove g2.

The first groove g1 and the second groove g2 may configure a main rolling part G1, and the first ball group BG1 and the main rolling part G1 may function as a main guide guiding the movement of the second carrier 300 in the optical axis (Z-axis) direction.

The third groove g3 and the fourth groove g4 may face each other in the direction perpendicular to the optical axis (Z-axis) direction, and some (e.g., second ball group BG2 described below) of the plurality of balls in the second ball member B2 may be disposed in a space between the third groove g3 and the fourth groove g4.

Among the plurality of balls included in the second ball group BG2, the balls disposed on the outermost side in the direction parallel to the optical axis (Z-axis) may be in two-point contact with either one of the third groove g3 and the fourth groove g4 and in one-point contact with the other one of the third groove g3 and the fourth groove g4.

For example, among the plurality of balls included in the second ball group BG2, the outermost balls in the direction parallel to the optical axis (Z-axis) may be in contact with the third groove g3 at one point and in two-point contact with the fourth groove g4 (and vice versa).

The third groove g3 and the fourth groove g4 may configure an auxiliary rolling part G2, and the second ball group BG2 and the auxiliary rolling part G2 may function as an auxiliary guide supporting the movement of the second carrier 300 in the optical axis (Z-axis) direction.

The second ball member B2 may include the first ball group BG1 and the second ball group BG2, and the first ball group BG1 and the second ball group BG2 may each include the plurality of balls disposed in the optical axis (Z-axis) direction.

The first ball group BG1 and the second ball group BG2 may be spaced apart from each other in the direction perpendicular to the optical axis (Z-axis) (e.g., Y-axis direction). The number of balls included in the first ball group BG1 and the number of balls included in the second ball group BG2 may differ.

For example, the first ball group BG1 may include two or more balls disposed in the optical axis (Z-axis) direction, and the second ball group BG2 may include fewer balls than the number of balls included in the first ball group BG1.

The number of balls belonging to each ball member may be changed under the premise that the number of balls belonging to the first ball group BG1 and the number of balls belonging to the second ball group BG2 are different from each other. Hereinafter, for convenience of explanation, the description is provided based on an embodiment where the first ball group BG1 includes three balls and the second ball group BG2 includes two balls.

Among three balls included in the first ball group BG1, two balls disposed on the outermost side in the direction parallel to the optical axis (Z-axis) may have the same diameter, and one ball disposed between these two balls may have a smaller diameter than the outermost balls.

For example, among the plurality of balls included in the first ball group BG1, each of the outermost two balls in the direction parallel to the optical axis (Z-axis) may have a first diameter, and one ball disposed therebetween may have a second diameter. Here, the first diameter is larger than the second diameter.

Two balls included in the second ball group BG2 may have the same diameter as each other. For example, two balls included in the second ball group BG2 may have a third diameter.

In addition, the first and third diameters may be the same. Here, the same diameter may indicate a diameter, including a manufacturing error and the physical same diameter.

A distance between the centers of the outermost balls in the direction parallel to the optical axis (Z-axis) among the plurality of balls included in the first ball group BG1 and a distance between the centers of the outermost balls in the direction parallel to the optical axis (Z-axis) among the plurality of balls included in the second ball group BG2 may be different from each other.

For example, the distance between the centers of two balls with the first diameter may be greater than the distance between the centers of two balls with the third diameter.

In order to secure that the second carrier 300 is moved to be parallel to the optical axis (Z-axis) when moved in the optical axis (Z-axis) direction (that is, to prevent the second carrier 300 from being tilted), a center point CP of the attraction acting between the third magnet 610 and the second yoke 690 may be desired to be positioned in a support region A which connects contact points of the second ball member B2 and the second carrier 300 (or the first carrier 200) to each other.

If the center point CP of the acting attraction deviates from the support region A, a position of the second carrier 300 may be shifted during its movement, which may cause the second carrier 300 to be tilted. Therefore, making the support region A as wide as possible is desirable.

In an embodiment of the present disclosure, each size (e.g., diameter) of some of the plurality of balls included in the second ball member B2 may be intentionally made smaller than each size (e.g., diameter) of the other balls. In this case, larger balls among the plurality of balls may be intentionally brought into contact with the second carrier 300 (or the first carrier 200).

Among three balls included in the first ball group BG1, the diameter of two balls may be larger than the diameter of the other ball, and two balls of the first ball group BG1 may respectively be in contact with the first carrier 200 and the second carrier 300. In addition, two balls of the second ball group BG2 may have the same diameter, and thus respectively be in contact with the first carrier 200 and the second carrier 300.

Therefore, as shown in FIG. 12, when viewed from the first axis direction (X-axis direction), the second ball member B2 may be in four-point contact with the first carrier 200 (or the second carrier 300). In addition, the support region A, which connects the contact points to one another, may have a rectangular shape (e.g., trapezoid).

Therefore, the support region A may be made wider, and the center point CP of the attraction acting between the third magnet 610 and the second yoke 690 may thus be stably positioned in the support region A. Accordingly, the camera module may secure its driving stability during the AF operation.

Meanwhile, even when two balls of the second ball group BG2 are manufactured to have the same diameter, two balls of the second ball group BG2 may not physically have exactly the same diameter due to the manufacturing error or the like. In this case, any one of two balls included in the second ball group BG2 may be in contact with the second carrier 300 (or the first carrier 200).

Accordingly, the support region A, which connects the contact points where the second ball member B2 are in contact with the second carrier 300 (or the first carrier 200), may have a triangular shape.

The support region A, even having the triangular shape, may still be wide by the outermost balls in the direction parallel to the optical axis (Z-axis), among three balls of the first ball member B1, thus allowing the camera module to secure its driving stability during the AF operation.

Apart from securing the driving stability of the camera module during the AF operation, it is also important for the camera module 1 to have a reduced height (or to be made slim) in the optical axis (Z-axis) direction. Here, a height of the support region A in the optical axis (Z-axis) direction may also be reduced when simply reducing the height of the camera module 1 in the optical axis (Z-axis) direction.

That is, when simply reducing the height of the camera module 1 in the optical axis (Z-axis) direction, a problem with its driving stability during the AF operation may occur.

In an embodiment of the present disclosure, an auxiliary yoke 691 may face the third magnet 610. For example, the auxiliary yoke 691 may be disposed on an inner side of the third coil 630 and face the third magnet 610.

The auxiliary yoke 691 may be closer to the main guide than to the auxiliary guide. The auxiliary yoke 691 may be made of a material capable of generating the attraction with the third magnet 610.

Therefore, a resultant force of the attraction acting between the third magnet 610 and the second yoke 690 and attraction acting between the third magnet 610 and the auxiliary yoke 691 may be positioned to be closer to the main guide than to the auxiliary guide.

In another embodiment, the third magnet 610 may be disposed on one outer surface of the second carrier 300 to be eccentric to one side in a length direction (e.g., second axis direction (Y-axis direction)) of the third magnet 610.

The center of one outer surface of the second carrier 300 and the center of the third magnet 610 may be misaligned with each other. The third magnet 610 may be eccentric to the main guide.

That is, the third magnet 610 may be closer to the main guide than to the auxiliary guide.

The closer the support region A is to the main guide, the longer length in the optical axis (Z-axis) direction. Therefore, it is possible to more stably position the center point CP of the acting attraction in the support region A by disposing the third magnet 610 to be closer to the main guide.

Meanwhile, the actuator 10 may detect the position of the second carrier 300 in the optical axis (Z-axis) direction.

To this end, a third position sensor 650 may be provided. The third position sensor 650 may be disposed on the second board 670 and face the third magnet 610. The third position sensor 650 may be the Hall sensor.

In the camera module 1, according to an embodiment of the present disclosure, the image sensor S may be moved in the optical axis (Z-axis) direction during the AF operation, and the image sensor S may be moved in the direction perpendicular to the optical axis (Z-axis) during the OIS operation.

In addition, the relative positions of the magnet and the coil included in the first driving unit 500 are not changed even when the image sensor S is moved in the optical axis (Z-axis) direction during the AF operation, and the cameral module 1 may thus precisely control its driving force for the OIS operation.

In addition, the relative positions of the magnet and the coil included in the second driving unit 600 are not changed even when the image sensor S is moved in the direction perpendicular to the optical axis (Z-axis) during the OIS operation, and the cameral module 1 may thus precisely control its driving force for the AF operation.

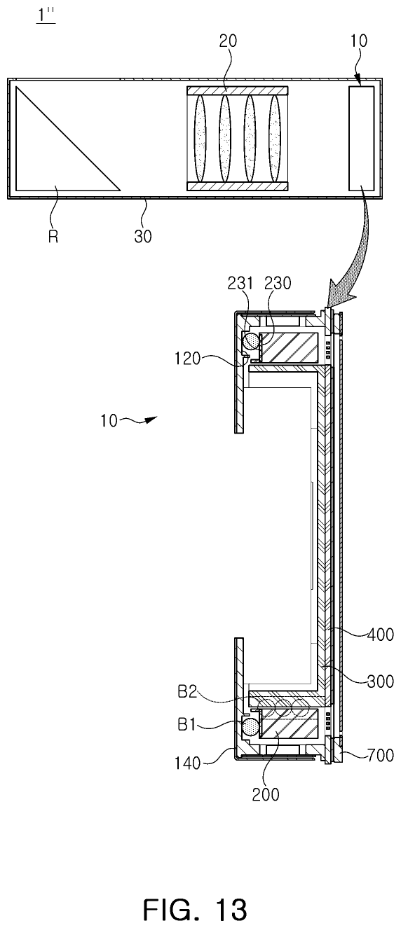

FIG. 13 is a schematic cross-sectional view of a camera module according to another embodiment of the present disclosure.

Referring to FIG. 13, according to another embodiment of the present disclosure, a camera module 1′ may include a housing 30, a reflection module R, the lens module 20, and the actuator 10.

In this embodiment, the optical axis (Z-axis) of the lens module 20 may be perpendicular to a thickness direction of a portable electronic device (i.e., direction from a front surface of the portable electronic device to its rear surface or vice versa).

For example, the optical axis (Z-axis) of the lens module 20 may be formed in the width direction or length direction of the portable electronic device.

A thickness of the portable electronic device may be increased when the parts included the camera module stacked in the thickness direction of the portable electronic device.

However, in the camera module 1′ of this embodiment, the optical axis (Z-axis) of the lens module 20 may be formed in the width direction or length direction of the portable electronic device, thereby reducing the thickness of the portable electronic device.

The reflection module R and the lens module 20 may be disposed in the housing 30. For example, the reflection module R and the lens module 20 may be fixed to the housing 30. Alternatively, it is also possible to dispose the reflection module R and the lens module 20 in separate housings, and couple the housings to each other.

The reflection module R may change a progression direction of light. For example, light incident into the housing 30 may change its progression direction to the lens module 20 through the reflection module R. The reflection module R may be a mirror or a prism that reflects light.

The actuator 10 may be accommodated in the housing 30 and disposed behind the lens module 20. For another example, the actuator 10 may be coupled to a rear end of the housing 30.

In this embodiment, the lens module 20 may be accommodated in the housing 30 of the camera module 1′ instead of being coupled to the housing 110 of the actuator 10. Accordingly, the housing 110 of the actuator 10 in this embodiment may have no part coupled to the lens module 20. The other configuration of the actuator 10 may be the same as the actuator 10 according to an embodiment of the present disclosure described above.

The image sensor S may be disposed in the actuator 10, may be moved in the first axis direction (X-axis direction) or the second axis direction (Y-axis direction), or may be rotated while having the optical axis (Z-axis) as its rotation axis. In addition, the image sensor S may be moved in the optical axis (Z-axis) direction.

Therefore, the camera module 1′ may perform the OIS operation or the AF operation by moving the image sensor S.

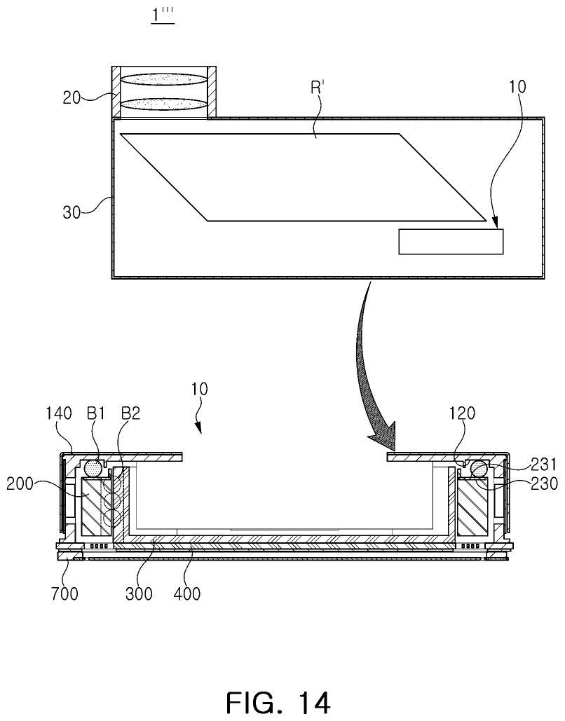

FIG. 14 is a schematic cross-sectional view of a camera module according to another embodiment of the present disclosure.

Referring to FIG. 14, according to another embodiment of the present disclosure, a camera module 1″ may include the housing 30, a reflection module R′, the lens module 20, and the actuator 10.

The reflection module R′ and the actuator 10 may be accommodated in the housing 30. For another example, the actuator 10 may be coupled to the housing 30 from the outside of the housing 30.

The reflection module R′ may change a progression direction of light. For example, light incident into the housing 30 may change its progression direction twice or more through the reflection module R′. To this end, the reflection module R′ may include two or more reflection surfaces. For example, a cross-section of the reflection module R′ may have a parallelogram shape.

The reflection module R′ may be a mirror or a prism that reflects light multiple times.

Light may be reflected multiple times by the reflection module R′ until light is received by the image sensor S, and thus have an optical path formed long in a limited space. In this way, the camera module 1″ may have a smaller size.

The lens module 20 may be disposed in front of the reflection module R′. For example, the lens module 20 may be closer to an object than the reflection module R′.

The optical axis (Z-axis) of the lens module 20 may be oriented in the thickness direction of the portable electronic device.

In this embodiment, the lens module 20 may be accommodated in the housing 30 of the camera module 1″ instead of being coupled to the housing 110 of the actuator 10. Accordingly, the housing 110 of the actuator 10 in this embodiment may have no part coupled to the lens module 20. The other configuration of the actuator 10 may be the same as the actuator 10 according to an embodiment of the present disclosure described above.

The image sensor S may be disposed in the actuator 10, may be moved in the first axis direction (X-axis direction) or the second axis direction (Y-axis direction), or may be rotated while having the optical axis (Z-axis) as its rotation axis. In addition, the image sensor S may be moved in the optical axis (Z-axis) direction.

Therefore, the camera module 1″ may perform the OIS operation or the AF operation by moving the image sensor S.

As set forth above, according to the embodiments of the present disclosure, the actuator for a camera may provide the improved autofocus and optical image stabilization performances.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An actuator for a camera, the actuator comprising:
a housing having an internal space;
a first carrier disposed in the housing;
a second carrier disposed in the first carrier;
an image sensor fixed to the second carrier;
a first driving unit configured to move the first carrier, relative to the housing, in a direction parallel to an imaging surface of the image sensor, the first driving unit comprising a coil portion disposed on the first carrier; and
a second driving unit configured to move the second carrier, relative to the first carrier, in a direction perpendicular to the imaging surface, the second driving unit comprising a first magnet disposed on the second carrier.

2. The actuator of claim 1, wherein the first driving unit further comprises
a first sub driving unit configured to move the first carrier in a first direction intersecting an optical axis, and
a second sub driving unit configured to move the first carrier in a second direction intersecting both the optical axis and the first direction.

3. The actuator of claim 2, wherein the coil portion comprises
a first coil included in the first sub driving unit, and
a second coil included in the second sub driving unit.

4. The actuator of claim 3, wherein the second driving unit comprises a third coil disposed on the first carrier, and
the third coil faces the first magnet disposed on the second carrier.

5. The actuator of claim 3, wherein the first coil comprises a plurality of first coils, and
the second coil comprises a plurality of second coils.

6. The actuator of claim 2, wherein the second driving unit overlaps the first sub driving unit in the first direction.

7. The actuator of claim 6, further comprising a Hall sensor facing the first magnet.

8. The actuator of claim 2, wherein the first sub driving unit comprises a second magnet disposed in the housing, and
the second sub driving unit comprises a third magnet disposed in the housing.

9. The actuator of claim 2, wherein the first sub driving unit is configured to generate a driving force in the first direction, and
the second sub driving unit is configured to generate a driving force in the second direction.

10. The actuator of claim 1, wherein the first driving unit comprises a second magnet disposed in the housing.

11. The actuator of claim 10, wherein the second magnet has north (N) and south (S) poles disposed in the direction perpendicular to the imaging surface.

12. The actuator of claim 1, wherein the first magnet has north (N) and south (S) poles disposed in a direction parallel to an optical axis.

13. The actuator of claim 1, the second driving unit comprises a Hall sensor facing the first magnet.

14. The actuator of claim 1, further comprising a sensor board comprising
a moving part on which the image sensor is disposed,
a fixed part mounted on the housing, and
a connecting part connecting the moving part and the fixed part to each other.

15. The actuator of claim 14, wherein the moving part is coupled to the second carrier.

16. The actuator of claim 14, wherein the connecting part is disposed along a perimeter of the moving part.
